(19) United States
(12) Patent Application Publication
(10) Pub. No.: US 2021/0042470 A1
(43) Pub. Date: Feb. 11, 2021

(54) METHOD AND DEVICE FOR SEPARATING WORDS

(71) Applicant: BEIJING BYTEDANCE NETWORK TECHNOLOGY CO., LTD., Beijing (CN)

(72) Inventor: Jiangdong Deng, Beijing (CN)

(21) Appl. No.: 16/981,273

(22) PCT Filed: Nov. 20, 2018
(86) PCT No.: PCT/CN2018/116345

§ 371 Date: Sep. 15, 2020

(30) Foreign Application Priority Data
Sep. 14, 2018 (CN) 201811076566.7

(51) Int. Cl. G06F 40/295; G06F 40/205

(52) U.S. Cl. CPC G06F 40/295; G06F 40/205

(57) ABSTRACT

A method and a device for separating words are provided. The method includes obtaining a predetermined word collection and a text with words to be separated; based on the predetermined word collection, separating words in the text with words to be separated to obtain at least one word list; regarding a word list in the at least one word list, determining first information of words in the word list and determining second information of the words in the word list, and determining a probability of the word list based on the first information and the second information; and selecting a word list whose probability is maximal from the at least one word list as a result of separating words. The predetermined word collection is a word collection pre-generated based on a predetermined text collection; words in the predetermined word collection include first information and second information.

### CROSS-REFERENCE TO RELATED APPLICATION

The disclosure is the national phase application of International Patent Application No. PCT/CN2018/116345, filed on Nov. 20, 2018, which claims the priority benefit of CN application Ser. No. 201811076566.7, filed on Sep. 14, 2018, titled “METHOD AND DEVICE FOR SEPARATING WORDS” whose Applicant is Beijing Bytedance Network Technology Co., Ltd., and the entirety of both of the above-mentioned patent applications will be hereby incorporated by reference herein and made a part of this specification.

### TECHNICAL FIELD

The disclosure relates to a computer technical field, and more particularly to a method and a device for separating words.

### DESCRIPTION OF RELATED ART

Generally, word segmentation refers to Chinese word segmentation. Through the word segmentation, a Chinese character sequence can be segmented into one or more words.

Word segmentation is the basis of text mining Through the word segmentation, a computer can automatically identify sentence meanings. Here, the method for automatically identifying the sentence meanings by the computer through the word segmentation is also called a mechanical word segmentation method, and the main principle of the method is that a Chinese character string to be analyzed is matched with entries in a preset mechanized dictionary according to a certain strategy so as to determine target entries corresponding to the Chinese character string to be analyzed.

### SUMMARY

Embodiments of the disclosure provide a method and a device for separating words.

In a first aspect, an embodiment of the disclosure provides a method for separating words. The method includes obtaining a predetermined word collection and a text with words to be separated; based on the predetermined word collection, separating words in the text with words to be separated to obtain at least one word list; regarding a word list in the at least one word list, determining first information of words in the word list and determining second information of the words in the word list, and determining a probability of the word list based on the first information and the second information; and selecting a word list whose probability is maximal from the at least one word list as a result of separating words. The predetermined word collection is a word collection pre-generated based on a predetermined text collection; words in the predetermined word collection include first information and second information; the first information is configured for indicating a probability of words present in the predetermined text collection; for the words in the predetermined word collection, the second information is configured for indicating a probability of presenting the words in the predetermined text collection under a condition of presenting other words than the words; the second information of a word in the word list is second information determined based on a word adjacent to the word.

In a second aspect, an embodiment of the disclosure provides a device for separating words. The device includes a first obtaining unit disposed to obtain a predetermined word collection and a text with words to be separated; a text separating unit disposed to separate words in the text with words to be separated to obtain at least one word list based on the predetermined word collection; a probability determining unit, disposed to generate a target matrix according to the coordinate collection; and a determining unit disposed to regarding a word list in the at least one word list, determine first information of words in the word list and determine second information of the words in the word list, and determine a probability of the word list based on the first information and the second information; and a list selecting unit disposed to select a word list whose probability is maximal from the at least one word list as a result of separating words. The predetermined word collection is a word collection pre-generated based on a predetermined text collection; words in the predetermined word collection include first information and second information; the first information is configured for indicating a probability of words present in the predetermined text collection; for the words in the predetermined word collection, the second information is configured for indicating a probability of presenting the words in the predetermined text collection under a condition of presenting other words than the words; the second information of a word in the word list is second information determined based on a word adjacent to the word;

In a third aspect, an embodiment of the disclosure provides an electronic device. The electronic device includes one or more processors and a storage device stored with one or more programs therein; and when the one or more programs are executed by the one or more processors, the one or more processors perform any method in the forgoing methods for separating words.

In a fourth aspect, an embodiment of the disclosure provides a computer readable medium, stored with a computer program therein. The computer program is executed by a processor to perform any method in the forgoing methods for separating words.

### BRIEF DESCRIPTION OF THE DRAWINGS

According to the detailed description of unlimited embodiments with reference to figures as below, other features, objectives and advantages of the disclosure will be more obvious.

FIG. 1 is an exemplary system architecture diagram applied with an embodiment of the disclosure.

FIG. 2 is a flowchart of a method for separating words according to an embodiment of the disclosure.

FIG. 3 is a schematic view of an application scenario of a method for separating words according to an embodiment of the disclosure.

FIG. 4 is a flowchart of a method for separating words according to another embodiment of the disclosure.

FIG. 5 is a structural schematic view of a device for separating words according to an embodiment of the disclosure.

FIG. 6 is a structural schematic view of a computer system for implementing an electronic device adapted for an embodiment of the disclosure.

### DETAILED DESCRIPTION OF PREFERRED EMBODIMENTS

The present application will be further described in detail in combination with accompanying drawings and embodiments. It should be understood that specific embodiments described herein are only for the purpose of explanation of the relevant application, rather than to limit the application. It should also be noted that, for convenience of description, only portions related to the relevant application are shown in the accompanying drawings.

It should be noted that, in the case of no conflict, the embodiments of the present application and features of the embodiments can be combined with each other. The present application will be described in detail below with reference to the accompanying drawings in combination with the embodiments.

The method and the device for separating words provided by the embodiments of the disclosure obtain a predetermined word collection and a text with words to be separated; the predetermined word collection is a word collection pre-generated based on a predetermined text collection; words in the predetermined word collection include first information and second information; the first information is configured for indicating a probability of words present in the predetermined text collection; for the words in the predetermined word collection, the second information is configured for indicating a probability of presenting the words in the predetermined text collection under a condition of presenting other words than the words; then based on the predetermined word collection, words in the text with words to be separated are separated to obtain at least one word list; regarding a word list in the at least one word list, first information and second information of the words in the word list are then determined, and a probability of the word list is determined based on the first information and the second information; the second information of a word in the word list is second information determined based on a word adjacent to the word; a word list whose probability is maximal is selected from the at least one word list as a result of separating words, which can efficiently utilize the first information and the second information of words to determine the result of separating words, and improve the accuracy of separating words.

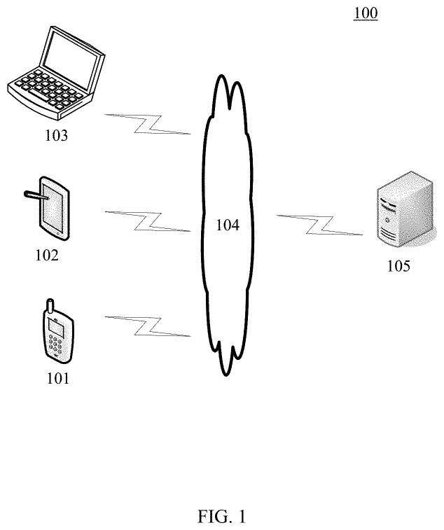

FIG. 1 shows an exemplary architecture 100 able to employ a method for separating words or a device for separating words of an embodiment of the disclosure.

As shown in FIG. 1, system architecture 100 may comprise terminal equipment 101, 102 and 103, a network 104 and a server 105. The network 104 is used for providing a medium of a communication link between the terminal equipment 101, 102 and 103 and the server 105. The network 104 may comprise various connection types, such as wired and wireless communication links or an optical fiber.

The terminal equipment 101, 102 and 103 interact with the server 105 via the network 104 to receive or send messages. Various client applications, such as web browser applications, search applications, instant messaging tools, and social platform software, can be installed in the terminal equipment 101, 102 and 103.

The terminal equipment 101, 102 and 103 may be hardware or software. When being hardware, the terminal equipment 101, 102 and 103 may be various kinds of electronic equipment capable of supporting image storage and image processing, including but not limited to smart phones, tablet personal computers, e-book readers, laptop portable computers, desk computers, etc. When being software, the terminal equipment 101, 102 and 103 can be installed in the electronic equipment listed above. The terminal equipment may be implemented as multiple pieces of software or software modules (such as multiple pieces of software or software modules used for providing distributed service), may also be implemented as a single piece of software or software module, which is not limited herein.

The server 105 may be the one for providing various services, such as a text processing server used for separating words sent by the terminal equipment 101, 102 and 103. The text processing server can process data such as a received text with words to be separated by analysis to obtain a processing result (such as a separation result).

It should be noted that the server may be hardware or software. When being hardware, the server may be implemented as a distributed server cluster including a plurality of servers, and may also be implemented as the single server. When being software, the server may be implemented as multiple pieces of software or software modules (such as multiple pieces of software or software modules used for providing distributed service), and may also be implemented as a single piece of software or software module, which is not limited herein.

It should be understood that numbers of the terminal equipment, the network and the server in FIG. 1 are exemplary only. Any number of terminal equipment, networks and servers may be provided according to implementation requirements. In a situation of data of the text with words to be separated or in a process of generating a separation result corresponding to the text with words to be separated unnecessary to be obtained from long-distance, the system architecture can exclude the network, and only include a terminal device or a server.

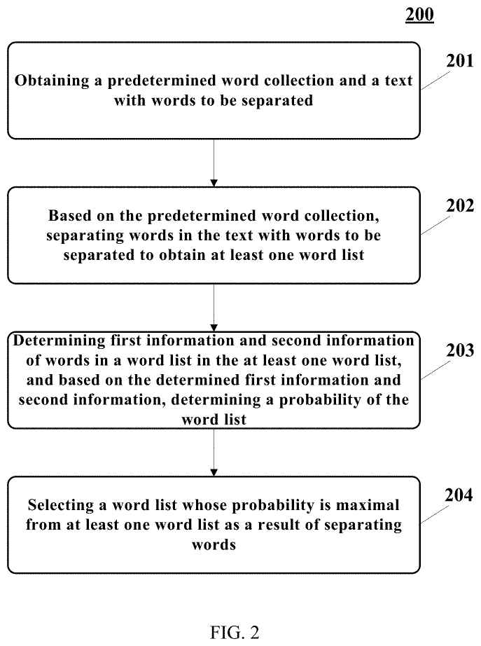

Referring to FIG. 2, FIG. 2 shows a flowchart 200 of a method for separating words according to an embodiment of the disclosure. The method for separating words includes following steps.

Step 201, a predetermined word collection and a text with words to be separated.

In the embodiment, an executive body (as a server shown in FIG. 1) for separating words can first obtain the predetermined word collection and the text with words to be separated from a terminal (such as the terminal device shown in FIG. 1) connected thereto for communication in a wired connection manner or a wireless connection manner or from the local. The text with words to be separated is a text whose words will be separated, which can include a phrase, a sentence or an article containing words.

The predetermined word collection is a word collection configured for separating words. The predetermined word collection can be pre-generated based on a predetermined text collection. The predetermined texts are texts configured for obtaining the word collection for separating words predetermined by a technician, such as a search term (the search term is a word, a phrase or a sentence for searching), an article published in a website, or news in a newspaper. Words in the predetermined word collection include first information and second information. The first information is configured for indicating a probability of a word presented in the predetermined text collection, which can include but not limited to at least one of: a word, a number and a symbol. Regarding the words in the predetermined word collection, the second information of the word is configured for indicating a probability of the word presented in the predetermined text collection with presenting words excluding the word as a condition, which can include but not limited to at least one of: a word, a number and a symbol.

As an example, the predetermined text collection includes two predetermined texts, which respectively are “weather today” and “the sunshine today brings sunshine to my mood”. The predetermined word collection obtained based on the predetermined text collection can includes words of “today”, “weather”, “sunshine” and “mood”.

The first information will be analyzed. Regarding the word “today” in predetermined word collection, it can be seen that two predetermined texts both include “today”, and the first information corresponding to “today” can be “one: 100%”; regarding the word “weather”, it can be seen that only the first predetermined text includes “weather”, and the first information corresponding to “weather” can be “one: 50%”; regarding the word “sunshine”, it can be seen that only the second predetermined text includes “sunshine”, and the first information corresponding to “sunshine” can be “one: 50%”; regarding the word “mood”, it can be seen that only the second predetermined text includes “mood”, and the first information corresponding to “mood” can be “one: 50%”. It needs to be illustrated that regarding the word “sunshine”, although the word appears twice, both in the second predetermined text, and absent in the first predetermined text, hence the first information of the word is “one: 50%”.

The second information is subsequently analyzed. Regarding the word “today”, following analysis is included. It can be seen that when the appearance of the word “weather” is a condition, the probability of presenting the word “today” is 100%, hence the second information of the word “today” corresponding to the word “weather” can be “two: 100%”; when the appearance of the word “sunshine” is a condition, the probability of presenting the word “today” is 100%, hence the second information of the word “today” corresponding to the word “sunshine” can be “two: 100%”; when the appearance of the word “mood” is a condition, the probability of presenting the word “today” is 100%, hence the second information of the word “today” corresponding to the word “mood” can be “two: 100%”.

Regarding the word “weather”, following analysis is included. It can be seen that when the appearance of the word “today” is a condition, the probability of presenting the word “weather” is 50%, hence the second information of the word “weather” corresponding to the word “today” can be “two: 50%”; when the appearance of the word “sunshine” is a condition, the probability of presenting the word “weather” is 0%, hence the second information of the word “weather” corresponding to the word “sunshine” can be “two: 0%”; when the appearance of the word “mood” is a condition, the probability of presenting the word “weather” is 0%, hence the second information of the word “weather” corresponding to the word “mood” can be “two: 0%”.

According to the analysis, it can determine that the second information of the word “sunshine” corresponding to the word “today” can be “two: 50%”, the second information corresponding to the word “weather” can be “two, 0%”, and the second information corresponding to the word “mood” can be “two, 100%”. The second information of the word “mood” corresponding to the word “today” can be “two: 50%”, the second information corresponding to the word “weather” can be “two, 0%”, and the second information corresponding to the word “sunshine” can be “two, 100%”.

In some optional embodiments, the predetermined word collection can be obtained by following generation steps.

Step 2011, a predetermined text collection and a pre-marked sample result of separating words aiming at predetermined texts in the predetermined text collection are obtained.

The sample result of separating words can be a result pre-marked by a technician. In practice, a result of separating words can be a word list composed of words obtained by separating words. For instance, a sample result of separating words corresponding to the predetermined text “weather today” can be a sample word list “today”; “weather”.

Step 2012, taking predetermined texts in the predetermined text collection as inputs, and taking a sample result of separating words corresponding to the input texts as an expected output, a model for separating words is obtained by training utilizing a machine learning method.

The model for separating words can be configured for indicating a corresponding relation of a text and a result of separating words. Specifically, the model for separating words can be obtained by training various conventional models configured for processing languages such as Conditional Random Field (CRF) and Hidden Markov Model (HMM). It needs to illustrate that the method to obtain models for separating words by training is the widely known technology extensively researched and applied at present, which will not be repeated herein.

In some optional embodiments, it can first train at least two predetermined initial models to obtain at least two models for separating words. The initial models and the models for separating words are respectively corresponding. For instance, it can take CRF and HMM as two initial models to be trained to obtain models for separating words, which can be trained to obtain two models for separating words (including a model for separating words corresponding to CRF and a model for separating words corresponding to HMM).

Step 2013, a model for separating words is utilized to separate words of predetermined texts in the predetermined text collection to obtain a first result of separating words.

Specifically, it can input each predetermined text in the predetermined text collection into the model for separating words obtained in step 2012 to acquire a result of separating words, and the obtained result of separating words is determined as the first result of separating words.

In some optional embodiments, when at least two predetermined initial models are trained according to step 2012 to obtain at least two models for separating words, the step can further utilize the at least two models for separating words to separate words of predetermined texts in the predetermined text collection to obtain at least two first results of separating words. The first result of separating words and the model for separating words are respectively corresponding.

Step 2014, based on the obtained first result of separating words, an initial word collection is generated.

Words in the initial word collection include first information determined by the obtained first result of separating words.

Specifically, it can first select words from the obtained first result of separating words as words in the initial word collection. Then the probability of each word of the selected words present in the first result of separating words is determined to generate the first information of the corresponding word. Furthermore, it can generate the initial word collection based on the selected words and the first information of words.

It needs to illustrate that it can adopt various methods to select words from the obtained first result of separating words as words in the initial word collection. For instance, it can directly determine all words in the obtained first result of separating words as words in the initial word collection; or it can select words except for individual character from the first result of separating words as words in the initial word collection.

In some optional embodiments, when step 2014 obtains at least two first results of separating words, before step 2014, the generation step can further include selecting the same word from the obtained as least two first results of separating words; and step 2014 can include: generating the initial word collection based on the selected words and the obtained first result of separating words.

Step 2015, based on the initial word collection, words of predetermined texts in the predetermined text collection are separated to obtain a second result of separating words.

Specifically, based on the initial word collection, it can separate words of predetermined texts in the predetermined text collection by various methods to obtain the result of separating words, and the obtained result of separating words is determined as the second result of separating words. For instance, it can adopt the forward maximum matching algorithm, the reverse maximum matching algorithm, the forward minimum matching algorithm or the reverse minimum matching algorithm to separate words of predetermined texts in the predetermined text collection to obtain the result of separating words. Conceivably, words in the second result of separating words are included in the initial word collection, and hence words in the second result of separating words further include the first information.

It needs to illustrate that the method to separate words of texts based on a word collection is the widely known technology extensively researched and applied at present, which will not be repeated herein.

Step 2016, based on the initial word collection and the obtained second result of separating words, a predetermined word collection is generated.

Words in the predetermined word collection include the first information and the second information determined by the obtained second result of separating words.

Specifically, it can first select words from the initial word collection as words in the predetermined word collection. For each word of the selected words, under the condition of other words present in the obtained second result of separating words, the conditional probability of the word present in the obtained second result of separating words (namely under the condition of other words present in the obtained second result of separating words, the probability of the word present in the obtained second result of separating words) is determined, and the second information of the word is further generated. Last, it can generate the predetermined word collection based on the selected words, the first information and the second information of the words. Conceivably, as words in the initial word collection include the first information, after determining the second information, the words in the predetermined word collection can include both of the first information and the second information.

It needs to be illustrated that various methods can be adopted to select words from the initial word collection as words in the predetermined word collection. For instance, it can directly determine all words in the obtained first result of separating words as words in the initial word collection; or it can select words whose probability is larger than a predetermined threshold indicated by the first information included therein from the obtained initial word collection as words in the predetermined word collection.

It further needs to illustrate that in practice, the executive body of the generation steps above for generating the predetermined word collection can be identical to or different from the executive body of the method for separating words. If they are the same, the executive body of the generation steps above for generating the predetermined word collection can store the predetermined word collection locally after obtaining the predetermined word collection. If they are different, the executive body of the generation steps above for generating the predetermined word collection can send the predetermined word collection to the executive body of the method for separating words after obtaining the predetermined word collection.

Step 202, based on the predetermined word collection, words in a text with words to be separated are separated to obtain at least a word list.

In the embodiment, based on the predetermined word collection obtained in step 201, the executive body above can separate words in the text with words to be separated to obtain at least one word list.

Specifically, the executive body can adopt at least two predetermined methods to separate words in the text with words to be separated based on the predetermined word collection to obtain at least one word list. It needs to be illustrated that it can obtain the same word list by two different methods to separate words in the text with words to be separated. Therefore, the executive body above can adopt at least two predetermined methods to obtain at least one word list.

In some optional embodiments, the executive body above can further separate words in the text with words to be separated to obtain at least one word list by following steps. First, the executive body can match the text with words to be separated and the predetermined text format to determine whether the texts with words to be separated include a text matching the predetermined text format or not. Then, the executive body above can separate words in the text with words to be separated to obtain at least one word list in response to determining that it includes a matched text based on the predetermined word collection. The word list includes the determined matched text. The predetermined text format is a format predetermined by a technician. The predetermined text format can be configured for indicating a text in accordance with a predetermined rule. For instance, a predetermined text format can be “x year y month z day”, where x, y and z can be configured for indicating any number. Moreover, the predetermined text format can be configured for indicating a text depicting the date (date including year, month and day).

Furthermore, exemplarily, the predetermined text format is “x year y month z day”. The text with words to be separated is “today is 2018 year 9 month 6 day”. The executive body above can separate words in the text with words to be separated by follow steps. First, the executive body above matches the text with words to be separated “today is 2018 year 9 month 6 day” and the predetermined text format “x year y month z day” to obtain the matched text “2018 year 9 month 6 day”. Then, regarding the unmatched text “today is”, the executive body above can separate words in the unmatched text based on the predetermined word collection, which can obtain results of “today” and “is”. Last, the executive body above can regard the matched text “2018 year 9 month 6 day” as words in the word list, which can form a final word list of “today”, “is” and “2018 year 9 month 6 day” with the results of “today” and “is”.

In some optional embodiments, the executive body above can further separate words in the text with words to be separated to obtain at least one word list by following steps. First, the executive body can identify a named entity of the text with words to be separated to determine whether the text with words to be separated includes a named entity or not. Then, the executive body above can separate words in the text with words to be separated to obtain at least one word list in response to determining that it includes a named entity based on the predetermined word collection. The word list includes the named entity. The named entity indicates a name, an organization name, a toponym and all the other entities with names as marks. The entity herein represents a word.

Specifically, the executive body above can adopt various methods to identify a named entity of the text with words to be separated. For instance, a technician can first establish a named entity collection, and the executive body above can match the text with words to be separated and named entities in the named entity collection to determine whether the text with words to be separated includes a named entity or not; or the executive body above can utilize a pre-trained model identifying a named entity to identify the text with words to be separated for determining whether the text with words to be separated includes a named entity or not. The model identifying a named entity can be obtained by training various conventional models configured for processing languages (such as CRF, HMM, etc.). It needs to illustrate that the method to obtain a model identifying a named entity by training is the widely known technology extensively researched and applied at present, which will not be repeated herein.

As an example, the text with words to be separated is “today is the birthday of Lisi”, and the executive body above can separate words in the text with words to be separated by following steps. First, the executive body above can identify a named entity of the text with words to be separated “today is the birthday of Lisi” to obtain a named entity “Lisi”. Then, the executive body above can separate words of the unnamed entity “today is the birthday of” based on the predetermined word collection to obtain results of “today”, “is”, “the”, “birthday” and “of”. Last, the executive body above can regard the obtained named entity “Lisi” as a word in the word list, which can form a final word list of “today”, “is”, “the”, “birthday”, “of” and “Lisi” with the results of “today”, “is”, “the”, “birthday” and “of”.

Step 203, first information and second information of words in the word list of the at least one word list are determined; the probability of the word list is determined based on the determined first information and second information.

In the embodiment, the executive body above can determine the first information and the second information of the words in the word list of at least one word list obtained in step 202, and determine the probability of the word list based on the determined first information and second information. The second information of the words in the word list is second information determined based on a word adjacent thereto.

Conceivably, as the words in the word list obtained based on the predetermined word collection are included in the predetermined word collection, the words in the predetermined word collection can include some second information (corresponding to the condition of presenting different words). The second information of the words in the word list is second information with the condition of presenting a word adjacent to the word.

In some optional embodiments, the second information of the words in the word list can be second information determined based on a previous word adjacent to the word.

In some optional embodiments, when the second information of the words in the word list is second information determined based on a previous word adjacent to the word, the executive body above can determine the second information of the words by following steps. First, the executive body above can determine whether the word list includes a previous word adjacent to the word or not. Then, the executive body above can determine the second information of the words based on the previous word adjacent to the word in response to determining the word list containing a previous word adjacent to the word.

Specifically, the executive body above further can determine the predetermined second information as the second information of the word in response to confirming the word list excluding a previous word adjacent to the word. The predetermined second information includes a probability predisposed by a technician.

In the embodiment, the executive body above can determine the probability of the word list in the obtained at least one word list by various methods based on the confirmed first information and second information. For instance, it can first sum up the probability indicated by the first information and the probability indicated by the second information of each word in the word list to obtain a total number as the probability corresponding to the word; then the probability corresponding to each word in the word list is summed up to obtain a total result of the probability of the word list.

Step 204, a word list whose probability is maximal is selected from the at least one word list as a result of separating words.

In the embodiment, based on the at least one word list obtained in step 202 and the probability of the word list obtained in step 203, the executive body above can select a word list whose probability is maximal can be selected from the at least one word list as the result of separating words.

It needs to illustrate that the executive body above can directly regard the word list as the result of separating words when the at least one word list merely includes one word list.

In some optional embodiments, after selecting the word list whose probability is maximal from the at least one word list, the executive body above can further execute following steps.

First, the executive body above can obtain a predetermined candidate word collection. Words in the predetermined candidate word collection are configured for indicating but not limited to at least one of: a movie name, a TV series name and a music name.

Then, the executive body above can match the result of separating words in step 204 and words in the candidate word collection to determine whether the result of separating words includes a phrase matching the words in the candidate word collection or not. The phrase includes at least two adjacent words.

Finally, in response to determining the result of separating words includes a phrase matching the words in the candidate word collection, the executive body above can determine the matched phrase as new words, and generate a new result of separating words containing the new words.

As an example, the result of separating words is “I”, “like”, “fate” and “symphony”. The candidate word collection includes the music name “fate symphony”. However, after matching the result of separating words which is “I”, “like”, “fate” and “symphony” and the candidate word collection, the executive body above can determine the result of separating words includes a matched phrase “fate” and “symphony”. Hence the executive body above can determine the matched phrase “fate” and “symphony” as a new word “fate symphony”, and generate a new result of separating words “I”, “like” and “fate symphony”.

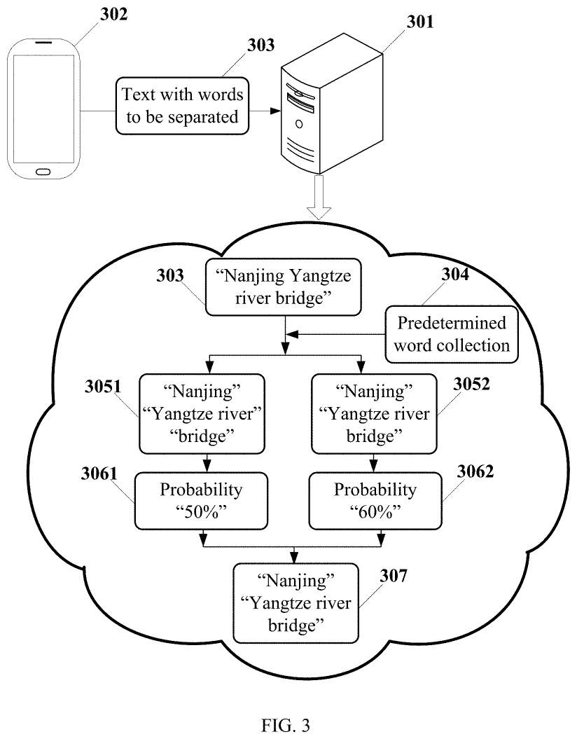

Referring to FIG. 3, FIG. 3 is a schematic view of an application scenario of a method for separating words according to the embodiment. In the application scenario of FIG. 3, a server 301 first obtains a text with words to be separated 303 which is “Nanjing Yangtze river bridge” from a terminal 302 connected thereto for communication, and obtains a predetermined word collection 304 locally. The predetermined word collection is a word collection pre-generated based on the predetermined text collection. Words in the predetermined word collection include first information and second information. The first information is configured for indicating a probability of a word present in the predetermined text collection. Regarding a word in the predetermined word collection, the second information is configured for indicating a probability of the word present in the predetermined text collection under the condition of presenting words other than the word. Then, the server 301 can separate words in the text with words to be separated 303 based on the predetermined word collection 304 to obtain a word list 3051 (such as “Nanjing”, “Yangtze river” and “bridge”) and a word list 3052 (such as “Nanjing” and “Yangtze river bridge”). Then, the server 301 can determine first information and second information of the words in the word list 3051, and determine a probability 3061 (such as 50%) of the word list based on the determined first information and second information. Identically, the server 301 can determine first information and second information of the words in the word list 3052, and determine a probability 3062 (such as 60%) of the word list based on the determined first information and second information. The second information of a word in the word list is second information determined based on a word adjacent to the word. Last, as the probability 3062 is higher than the probability 3061 (60% is higher than 50%), the sever 301 can select the word list 3052 as a result of separating words 307.

The method provided by the forgoing embodiment of the disclosure effectively utilizes the first information and the second information to determine the result of separating words, which can improve the accuracy of separating words.

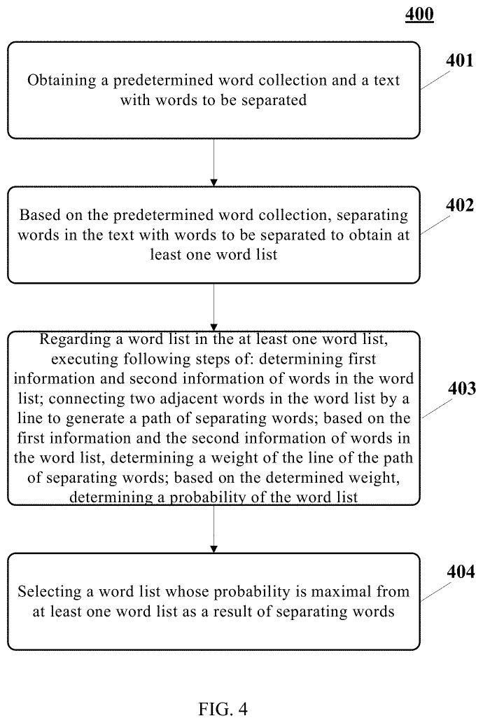

Referring to FIG. 4, FIG. 4 shows a process 400 of a method for separating words according to another embodiment. The process 400 of a method for separating words includes following steps.

Step 401, a predetermined word collection and a text with words to be separated are obtained.

In the embodiment, an executive body (as a server shown in FIG. 1) for separating words can first obtain the predetermined word collection and the text with words to be separated from a terminal (such as the terminal device shown in FIG. 1) connected thereto for communication in a wired connection manner or a wireless connection manner or from the local. The text with words to be separated is a text whose words will be separated, which can include a phrase, a sentence or an article containing words.

The predetermined word collection is a word collection configured for separating words. The predetermined word collection can be pre-generated based on a predetermined text collection. The predetermined texts are texts configured for obtaining the word collection for separating words predetermined by a technician.

Step 402, based on the predetermined word collection, words in the text with words to be separated are separated to obtain at least one word list.

In the embodiment, based on the predetermined word collection obtained in step 401, the executive body above can separate words in the text with words to be separated to obtain at least one word list.

Step 403, with respect to the word list in the at least one word list, following steps are performed. First information and second information of words in the word list are determined; two adjacent words in the word list are connected to generate a path of separating words; based on the first information and the second information in the word list, a weight of a line of the path of separating words is determined; based on the determined weight, a probability of the word list is determined.

In the embodiment, with respect to the word list in the at least one word list obtained in step 402, the executive body can perform following steps.

Step 4031, first information and second information of words in the word list.

The step is identical to step 203 in the embodiment corresponding to FIG. 2 with the same method of determining the first information and the second information of words in the word list therein, which will not be repeated herein.

Step 4032, two adjacent words in the word list are connected to generate a path of separating words.

Nodes of the path of separating words are indicated by words in the word list, and a line of the path of separating words is a line configured for connecting words. For instance, the word list is “Nanjing”, “Yangtze river” and “bridge”, and the corresponding path of separating words can be “Nanjing-Yangtze river-bridge”. Conceivably, the path of separating words is configured for indicating a virtual path of a process of separating words.

Step 4033, based on the first information and the second information of words in the word list, a weight of a line of the path of separating words is determined.

The weight of the line of the path of separating words is configured for indicating the importance degree of the manner to separate words represented by the line. The manner to separate words represented by the line depicts a manner to separate words of separating words to obtain two words connected by the line.

Determining a weight of a line of the path of separating words based on first information and second information of words in the word list specifically indicates determining the weight of the path of separating words based on a probability indicated by the first information and a probability indicated by the second information in the word list.

Specifically, the executive body above can adopt various methods to determine the weight of the line based on the probability indicated by the first information and the probability indicated by the second information of two words connected by each line in lines included in the path of separating words. For instance, the second information of the latter word of the two words is the second information corresponding to the former word. It can sum up the probability indicated by the first information of the former word and the probability indicated by the second information of the latter word to obtain a total number, and the total number is determined as the weight of the line.

Optionally, when the second information of the latter word is the second information corresponding to the former word, it can further adopt the following formula to determine the weight of the line.

weight=α·log(p(wᵢ))+(1−α)·log(p(wᵢ|wᵢ₋₁))

Where the weight is configured for indicating a weight of the line; is configured for indicating the former word of two words connected by the line; wᵢ is configured for indicating the latter word of two words connected by the line; log is an operator of the logarithm operation; p(wᵢ) is configured for indicating a probability indicated by first information of the latter word; p(wᵢ|wᵢ₋₁) is configured for indicating a probability indicated by second information of the latter word corresponding to the former word; α is a predetermined coefficient which is larger than or equal to 0, and smaller than or equal to 1.

Step 4034, based on the determined weight, a probability of the word list is determined.

The executive body above can adopt various methods to determine the probability of the word list based on the determined weight. For instance, it can sum up weights of each line in the path of separating words generated by the word list to obtain a total number, and the obtained total number is determined as the probability of the word list; or it can sum up weights of each of the determined lines and probabilities indicated by first information of each word in the path of separating words to obtain a total number, and the obtained total number is determined as the probability of the word list.

Step 404, a word list whose probability is maximal is selected from the at least one word list as the result of separating words.

In the embodiment, based on the at least one word list obtain in step 402 and the probability of the word list obtained in step 403, the executive body above can select the word list whose probability is maximal from the at least one word list as the result of separating words.

The step 401, step 402 and step 404 respectively are identical to step 201, step 202 and step 204 in the forgoing embodiment. The illustration of step 201, step 202 and step 204 is adaptive to step 401, step 402 and step 404, which will not be repeated herein.

It can be seen from FIG. 4 that the process 400 of the method for separating words in the embodiment, compared with the embodiment corresponding to FIG. 2, emphasizes steps of generating the path of separating words based on the obtained word list, determining the weight of the line in the path of separating words, and determining the probability of the word list based on the determined weight. Therefore, the embodiment can introduce more data configured for determining the probability of the word list, which can separate the words more currently.

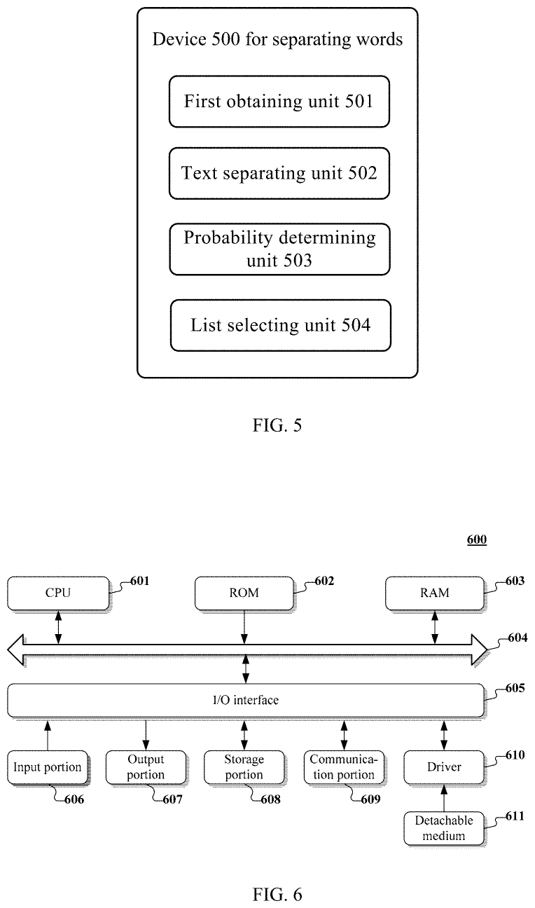

Referring to FIG. 5, as the implement of the methods as shown in forgoing figures, the disclosure provides an embodiment of a device for separating words. The device embodiment is corresponding to the method embodiment shown as FIG. 2. The device specifically can be applied in various electronic devices.

As shown in FIG. 5, a device for separating words 500 of the embodiment includes a first obtaining unit 501, a text separating unit 502, a probability determining unit 503 and a list selecting unit 504. The first obtaining unit 501 is disposed to obtain a predetermined word collection and a text with words to be separated; the predetermined word collection is a word collection pre-generated based on a predetermined text collection; words in the predetermined word collection include first information and second information; the first information is configured for indicating a probability of words present in the predetermined text collection; for the words in the predetermined word collection, the second information is configured for indicating a probability of presenting the words in the predetermined text collection under a condition of presenting other words than the words; the text separating unit 502 is disposed to separate words in the text with words to be separated to obtain at least one word list based on the predetermined word collection; the probability determining unit 503 is disposed to regarding a word list in the at least one word list, determine first information of words in the word list and determine second information of the words in the word list, and determine a probability of the word list based on the first information and the second information; the second information of a word in the word list is second information determined based on a word adjacent to the word; the list selecting unit 504 is disposed to select a word list whose probability is maximal from the at least one word list as a result of separating words.

In the embodiment, the first obtaining unit 501 of the device for separating words 500 can obtain the predetermined word collection and the text with words to be separated from a terminal (such as the terminal device shown in FIG. 1) connected thereto for communication in a wired connection manner or a wireless connection manner or from the local. The text with words to be separated is a text whose words will be separated, which can include a phrase, a sentence or an article containing words.

The predetermined word collection is a word collection configured for separating words. The predetermined word collection can be pre-generated based on a predetermined text collection. The predetermined texts are texts configured for obtaining the word collection for separating words predetermined by a technician.

In the embodiment, the predetermined word collection can be obtained by the first obtaining unit 501. The text separating unit 502 can separate words in the text with words to be separated to obtain at least one word list.

In the embodiment, the word list in the at least one word list can be obtained by the text separating unit 502. The probability determining unit 503 can determine the first information and the second information of words in the word list, and determine the probability of the word list based on the determined first information and second information. The second information of a word in the word list is second information determined based on a word adjacent to the word.

In the embodiment, the at least one word list can be obtained by the text separating unit 502, and the probability of the word list can be obtained by the probability determining unit 503; the list selecting unit 504 can select a word list whose probability is maximal from the at least one word list as a result of separating words.

In some optional embodiments, the probability determining unit can include: a path generating module (not shown in figures) disposed to connect two adjacent words in the word list by a line to generate a path of separating words; nodes of the path of separating words are indicated by the words in the word list, and the line of the path of separating words is a line configured for connecting words; a weight determining module (not shown in figures) disposed to determine a weight of the line of the path of separating words based on the first information and the second information of the words in the word list; and a probability determining module (not shown in figures) disposed to determine the probability of the word list based on the weight.

In some optional embodiments, the second information of the word in the word list is second information determined based on a previous word adjacent to the word.

In some optional embodiments, the probability determining unit 503 can further be disposed to: for the word in the word list, execute following steps of: determining whether the word list includes a previous word adjacent to the word or not; in response to determining to include the previous word adjacent to the word, determining the second information of the word based on the previous word adjacent to the word.

In some optional embodiments, the predetermined word collection is obtained by following generation steps of: obtaining the predetermined text collection and a sample result of separating words pre-marked aiming at predetermined texts in the predetermined text collection; taking the predetermined texts in the predetermined text collection as inputs, taking the sample result of separating words corresponding to the predetermined texts as an expected output, utilizing a machine leaning method, training to obtain a model for separating words; utilizing the model for separating words to separate words in the predetermined texts in the predetermined text collection to obtain a first result of separating words; based on the first result of separating words, generating an initial word collection; words in the initial word collection include the first information determined by the first result of separating words; based on the initial word collection, separating the words in the predetermined texts in the predetermined text collection to obtain a second result of separating words; and based on the initial word collection and the second result of separating words, generating the predetermined word collection; the predetermined word collection includes the first information and the second information determined based on the second result of separating words.

In some optional embodiments, training to obtain a model for separating words includes: training at least two predetermined initial models to obtain at least two models for separating words; and the process of utilizing the model for separating words to separate words in the predetermined texts in the predetermined text collection to obtain a first result of separating words includes: utilizing the at least two models for separating words to separate the words in the predetermined texts in the predetermined text collection to obtain at least two first results of separating words.

In some optional embodiments, before based on the first result of separating words, generating an initial word collection, the generation steps further include: extracting identical words from the at least two first results of separating words; and the process of based on the first result of separating words, generating an initial word collection includes: based on extracted words and the first result of separating words, generating the initial word collection.

In some optional embodiments, the text separating unit 502 can include: a text matching module (not shown in figures), which is disposed to match the text with words to be separated and a predetermined text format to determine whether the text with words to be separated includes a text matching the predetermined text format or not; and a first separating module (not shown in figures), which is disposed to in response to determining to include the text, based on the predetermined word collection and the text, separate the words in the text with words to be separated to obtain the at least one word list; the at least one word list includes the text.

In some optional embodiments, the text separating unit 502 can include: a text identifying module (not shown in figures), which is disposed to identify a named entity in the text with words to be separated to determine whether the text with words to be separated includes the named entity or not; and a second separating module (not shown in figures), which is disposed to in response to determining to include the named entity, based on the predetermined word collection and the named entity, separate the words in the text with words to be separated to obtain the at least one word list; the at least one word list includes the named entity.

In some optional embodiments, the device 500 can further include: a second obtaining unit (not shown in figures), which is disposed to obtain a predetermined candidate word collection; words in the predetermined candidate word collection are configured for indicating at least one of: a movie name, a TV series name and a music name; a word matching unit (not shown in figures), which is disposed to match the result of separating words and the words in the predetermined candidate word collection to determine whether the result of separating words includes a phrase matching the words in the predetermined candidate word collection or not; the phrase includes at least two adjacent words; and a result generating unit (not shown in figures), which is disposed to in response to determining to include the phrase, determine the phrase as an updated word, and generate an updated result of separating words comprising the updated word.

Conceivably, each unit reported in the device 500 is corresponding to each step in the method described by FIG. 2. Therefore, processes, features and generated beneficial effects described aiming at the method are adaptive for the device 500 and units included therein, which will not be repeated herein.

The device 500 provided by the forgoing embodiment of the disclosure efficiently utilizes the first information and the second information of words to determine the result of separating words, and improves the accuracy of separating words.

Reference is now made to FIG. 6 which shows a structure diagram of a computer system 600 of electronic equipment (such as the terminal device/server shown in FIG. 1) applicable to implementing an embodiment of the present application. The electronic equipment shown in FIG. 6 is merely an example and should not pose any limitation on functions and application ranges of the embodiments of the present application.

As shown in FIG. 6, the computer system 600 includes a central processing unit (CPU) 601 which can execute various appropriate actions and processes according to programs stored in a read-only memory (ROM) 602 or programs loaded to a random-access memory (RAM) 603 from a storage portion 608. Various programs and data required by operation of the system 600 are also stored in the RAM 603. The CPU 601, ROM 602 and RAM 603 are connected to one another through a bus 604. An input/output (I/O) interface 605 is also connected to the bus 604.

The I/O interface 605 is connected with following components: an input portion 606 including a keyboard, a mouse, etc.; an output portion 607 including a cathode-ray tube (CRT), a liquid crystal display (LCD), a loudspeaker, etc.; a storage portion 608 including a hard disk, etc.; and a communication portion 609 including a network interface card such as an LAN card and a modem. The communication portion 609 executes communication through networks such as the Internet. A driver 610 is also connected to the I/O interface 605 as required. A detachable medium 611, such as a magnetic disk, an optical disk, a magneto-optical disk and a semiconductor memory, is installed on the driver 610 as required, so that computer programs read from the detachable medium can be installed into the storage portion 608 as required.

Specifically, processes described above with reference to flowcharts may be implemented as computer software programs in accordance with embodiments of the present disclosure. For example, an embodiment of the present application comprises a computer program product which comprises a computer program carried on a computer readable medium, and the computer program comprises program codes used for executing the method shown in the flowchart. In such embodiment, the computer program may be downloaded from the network through the communication portion 609 and installed, and/or downloaded from the detachable medium 611 and installed. When the computer program is executed by the central processing unit (CPU) 601, a function defined in the method provided by the present application is executed. It should be noted that the computer readable medium of the present application may be a computer readable signal medium or a computer readable storage medium, or any combination of the computer readable signal medium or the computer readable storage medium. The computer readable storage medium may be, for example, but is not limited to, an electronic, magnetic, optical, electromagnetic, infrared, or semiconductor system, apparatus, or device, or combination of any of the above. More specifically, the computer readable storage medium may include, but is not limited to, an electrical connector having one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination of the above. In the present application, the computer readable storage medium may be any tangible medium that contains or stores a program that can be used by or in combination with an instruction execution system, apparatus, or device. In the present application, a computer readable signal medium may include a data signal propagating in a baseband or as a part of a carrier wave, and computer readable program codes are carried in the data signal. Such propagated data signal may be in various forms, including but not limited to an electromagnetic signal, an optical signal, or any appropriate combination of the above. The computer readable signal medium may also be any computer readable medium other than the computer readable storage medium, and the computer readable medium can transmit, propagate, or transport the program used by or in combination with the instruction execution system, apparatus, or device. The program codes included in the computer readable medium may be transmitted via any appropriate medium, including but not limited to wireless, electrical wires, optical cables, RF, etc., or any appropriate combination of the above.

The flowcharts and block diagrams in the figures illustrate the possible system architecture, functions, and operation of systems, methods, and computer program products according to various embodiments of the present application. In view of this, each block in the flowcharts or block diagrams may represent a module, a program segment, or a portion of codes, and the module, the program segment or the portion of codes contains one or more executable instructions for implementing specified logical functions. It should also be noted that in some alternative implementations, the functions labeled in the blocks may be implemented according to an order different from the order labeled in the figures. For example, the two blocks shown in succession may, in fact, be executed substantially concurrently, or may sometimes be executed in a reverse order, depending upon the functions involved. It should also be noted that each block in the block diagrams and/or flowcharts, and combinations of blocks in the block diagrams and/or flowcharts can be implemented by dedicated hardware-based systems used for carrying out the specified functions or operation, or can be implemented by combinations of dedicated hardware and computer instructions.

Units described in the embodiments of the present application may be implemented in a software mode or in a hardware mode. The described units may also be arranged in a processor, for example, the units can be described as follows: a processor includes an obtaining unit, a generating unit, and a determining unit, and the names of the units do not, in some cases, constitute limitation on the units themselves. For instance, the text separating unit can further be described as a unit for separating words in a text with words to be separated.

In another aspect, the present application also provides a computer readable medium which may be included in the electronic equipment described in the above embodiments, or may also present separately without being assembled into the electronic device. The above computer readable medium carries one or more programs. When one or more programs above are executed by the electronic device, the electronic device is enabled to obtain a predetermined word collection and a text with words to be separated; the predetermined word collection is a word collection pre-generated based on a predetermined text collection; words in the predetermined word collection comprise first information and second information; the first information is configured for indicating a probability of words present in the predetermined text collection; for the words in the predetermined word collection, the second information is configured for indicating a probability of presenting the words in the predetermined text collection under a condition of presenting other words than the words; based on the predetermined word collection, separating words in the text with words to be separated to obtain at least one word list; regarding a word list in the at least one word list, determining first information of words in the word list and determining second information of the words in the word list, and determining a probability of the word list based on the first information and the second information; the second information of a word in the word list is second information determined based on a word adjacent to the word; and selecting a word list whose probability is maximal from the at least one word list as a result of separating words.

The above description is merely the illustration of preferred embodiments of the present application and the technical principles used. It should be understood by those skilled in the art that the scope of the present application referred to herein is not limited to technical solutions formed by specific combinations of the above technical features, but also contains other technical solutions formed by any combination of the above technical features or equivalent features thereof without departing from the above inventive concept, such as, technical solutions formed by interchanging the above features with (but not limited to) the technical features with similar functions disclosed in the present application.

1. A method for separating words, comprising:
obtaining a predetermined word collection and a text with words to be separated; wherein the predetermined word collection is a word collection pre-generated based on a predetermined text collection; words in the predetermined word collection comprise first information and second information; the first information is configured for indicating a probability of words present in the predetermined text collection; for the words in the predetermined word collection, the second information is configured for indicating a probability of presenting the words in the predetermined text collection under a condition of presenting other words than the words;
based on the predetermined word collection, separating words in the text with words to be separated to obtain at least one word list;
regarding a word list in the at least one word list, determining first information of words in the word list and determining second information of the words in the word list, and determining a probability of the word list based on the first information and the second information; wherein the second information of a word in the word list is second information determined based on a word adjacent to the word; and
selecting a word list whose probability is maximal from the at least one word list as a result of separating words.

2. The method according to claim 1, wherein the determining a probability of the word list based on the first information and the second information comprises:
connecting two adjacent words in the word list by a line to generate a path of separating words; wherein nodes of the path of separating words are indicated by the words in the word list, and the line of the path of separating words is a line configured for connecting words;
based on the first information and the second information of the words in the word list, determining a weight of the line of the path of separating words; and
based on the weight, determining the probability of the word list.

3. The method according to claim 1, wherein the second information of the word in the word list is second information determined based on a previous word adjacent to the word.

4. The method according to claim 3, wherein the determining second information of the words in the word list comprises:
for the word in the word list, executing following steps of: determining whether the word list comprises a previous word adjacent to the word or not; in response to determining to comprise the previous word adjacent to the word, determining the second information of the word based on the previous word adjacent to the word.

5. The method according to claim 1, wherein the predetermined word collection is obtained by following generation steps of:
obtaining the predetermined text collection and a sample result of separating words pre-marked aiming at predetermined texts in the predetermined text collection;
taking the predetermined texts in the predetermined text collection as inputs, taking the sample result of separating words corresponding to the predetermined texts as an expected output, utilizing a machine leaning method, training to obtain a model for separating words;
utilizing the model for separating words to separate words in the predetermined texts in the predetermined text collection to obtain a first result of separating words;
based on the first result of separating words, generating an initial word collection; wherein words in the initial word collection comprise the first information determined by the first result of separating words;
based on the initial word collection, separating the words in the predetermined texts in the predetermined text collection to obtain a second result of separating words; and
based on the initial word collection and the second result of separating words, generating the predetermined word collection; wherein the predetermined word collection comprises the first information and the second information determined based on the second result of separating words.

6. The method according to claim 5, wherein the training to obtain a model for separating words comprises:
training at least two predetermined initial models to obtain at least two models for separating words; and
wherein the utilizing the model for separating words to separate words in the predetermined texts in the predetermined text collection to obtain a first result of separating words comprises:
utilizing the at least two models for separating words to separate the words in the predetermined texts in the predetermined text collection to obtain at least two first results of separating words.

7. The method according to claim 6, wherein before the based on the first result of separating words, generating an initial word collection, the generation steps further comprise:
extracting identical words from the at least two first results of separating words; and
wherein the based on the first result of separating words, generating an initial word collection comprises:
based on extracted words and the first result of separating words, generating the initial word collection.

8. The method according to claim 1, wherein the separating words in the text with words to be separated to obtain at least one word list comprises:
matching the text with words to be separated and a predetermined text format to determine whether the text with words to be separated comprises a text matching the predetermined text format or not; and
in response to determining to comprise the text, based on the predetermined word collection and the text, separating the words in the text with words to be separated to obtain the at least one word list; wherein the at least one word list comprises the text.

9. The method according to claim 1, wherein the separating words in the text with words to be separated to obtain at least one word list comprises:
identifying a named entity in the text with words to be separated to determine whether the text with words to be separated comprises the named entity or not; and
in response to determining to comprise the named entity, based on the predetermined word collection and the named entity, separating the words in the text with words to be separated to obtain the at least one word list; wherein the at least one word list comprises the named entity.

10. The method according to claim 1, wherein after the selecting a word list whose probability is maximal from the at least one word list as a result of separating words, the method further comprises:
obtaining a predetermined candidate word collection; wherein words in the predetermined candidate word collection are configured for indicating at least one of: a movie name, a TV series name and a music name;
matching the result of separating words and the words in the predetermined candidate word collection to determine whether the result of separating words comprises a phrase matching the words in the predetermined candidate word collection or not; wherein the phrase comprises at least two adjacent words; and
in response to determining to comprise the phrase, determining the phrase as an updated word, and generating an updated result of separating words comprising the updated word.

11-20. (canceled)

21. An electronic device, comprising:
one or more processors;
a storage device, stored with one or more programs therein; and
when the one or more programs are executed by the one or more processors, enabling the one or more processors to:
obtain a predetermined word collection and a text with words to be separated; wherein the predetermined word collection is a word collection pre-generated based on a predetermined text collection; words in the predetermined word collection comprise first information and second information; the first information is configured for indicating a probability of words present in the predetermined text collection; for the words in the predetermined word collection, the second information is configured for indicating a probability of presenting the words in the predetermined text collection under a condition of presenting other words than the words;
based on the predetermined word collection, separate words in the text with words to be separated to obtain at least one word list
regarding a word list in the at least one word list, determine first information of words in the word list and determining second information of the words in the word list, and determine a probability of the word list based on the first information and the second information; wherein the second information of a word in the word list is second information determined based on a word adjacent to the word; and
select a word list whose probability is maximal from the at least one word list as a result of separating words.

22. A computer readable medium, stored with a computer program therein, wherein the computer program is executed by a processor to perform a method comprising:
obtaining a predetermined word collection and a text with words to be separated; wherein the predetermined word collection is a word collection pre-generated based on a predetermined text collection; words in the predetermined word collection comprise first information and second information; the first information is configured for indicating a probability of words present in the predetermined text collection; for the words in the predetermined word collection, the second information is configured for indicating a probability of presenting the words in the predetermined text collection under a condition of presenting other words than the words;
based on the predetermined word collection, separating words in the text with words to be separated to obtain at least one word list
regarding a word list in the at least one word list, determining first information of words in the word list and determining second information of the words in the word list, and determining a probability of the word list based on the first information and the second information; wherein the second information of a word in the word list is second information determined based on a word adjacent to the word; and
selecting a word list whose probability is maximal from the at least one word list as a result of separating words.

23. The electronic device according to claim 21, wherein the storage device further stores the one or more programs that upon execution by the one or more processors cause the electronic device to:
connect two adjacent words in the word list by a line to generate a path of separating words; wherein nodes of the path of separating words are indicated by the words in the word list, and the line of the path of separating words is a line configured for connecting words;
based on the first information and the second information of the words in the word list, determine a weight of the line of the path of separating words; and
based on the weight, determine the probability of the word list.

24. The electronic device according to claim 21, wherein the second information of the word in the word list is second information determined based on a previous word adjacent to the word.

25. The electronic device according to claim 24, wherein the storage device further stores the one or more programs that upon execution by the one or more processors cause the electronic device to:
for the word in the word list, execute following steps of: determining whether the word list comprises a previous word adjacent to the word or not; in response to determining to comprise the previous word adjacent to the word, determining the second information of the word based on the previous word adjacent to the word.

26. The electronic device according to claim 21, wherein the predetermined word collection is obtained by following generation steps of:
obtaining the predetermined text collection and a sample result of separating words pre-marked aiming at predetermined texts in the predetermined text collection;
taking the predetermined texts in the predetermined text collection as inputs, taking the sample result of separating words corresponding to the predetermined texts as an expected output, utilizing a machine leaning method, training to obtain a model for separating words;
utilizing the model for separating words to separate words in the predetermined texts in the predetermined text collection to obtain a first result of separating words;
based on the first result of separating words, generating an initial word collection; wherein words in the initial word collection comprise the first information determined by the first result of separating words;
based on the initial word collection, separating the words in the predetermined texts in the predetermined text collection to obtain a second result of separating words; and
based on the initial word collection and the second result of separating words, generating the predetermined word collection; wherein the predetermined word collection comprises the first information and the second information determined based on the second result of separating words.

27. The electronic device according to claim 26, wherein the storage device further stores the one or more programs that upon execution by the one or more processors cause the electronic device to:
train at least two predetermined initial models to obtain at least two models for separating words; and
utilize the at least two models for separating words to separate the words in the predetermined texts in the predetermined text collection to obtain at least two first results of separating words.

28. The electronic device according to claim 27, wherein the storage device further stores the one or more programs that upon execution by the one or more processors cause the electronic device to:
extract identical words from the at least two first results of separating words; and
based on extracted words and the first result of separating words, generate the initial word collection.

29. The electronic device according to claim 21, wherein the storage device further stores the one or more programs that upon execution by the one or more processors cause the electronic device to:
match the text with words to be separated and a predetermined text format to determine whether the text with words to be separated comprises a text matching the predetermined text format or not; and
in response to determining to comprise the text, based on the predetermined word collection and the text, separate the words in the text with words to be separated to obtain the at least one word list; wherein the at least one word list comprises the text.

30. The electronic device according to claim 21, wherein the storage device further stores the one or more programs that upon execution by the one or more processors cause the electronic device to:
identify a named entity in the text with words to be separated to determine whether the text with words to be separated comprises the named entity or not; and
in response to determining to comprise the named entity, based on the predetermined word collection and the named entity, separate the words in the text with words to be separated to obtain the at least one word list; wherein the at least one word list comprises the named entity.
